(19) United States
(12) Patent Application Publication
(10) Pub. No.: US 2016/0274736 A1
(43) Pub. Date: Sep. 22, 2016

(54) SYNCHRONIZED MULTI-WINDOW INTERACTION WITH HIERARCHICAL DATA ON THIN-CLIENT

(71) Applicant: Microsoft Technology Licensing, LLC, Redmond, WA (US)

(72) Inventors: Andre Lamego, Seattle, WA (US); Alexandru Prodan, Seattle, WA (US); Arif Kureshy, Snohomish, WA (US); Christopher P. Lewis, Redmond, WA (US); David L. Parslow, Seattle, WA (US); Leckie P. Gunter, Renton, WA (US); Anees Ansari, Redmond, WA (US); Alex Stakh, Seattle, WA (US); Adrian L. Orth, West Fargo, ND (US)

(21) Appl. No.: 14/811,312

(22) Filed: Jul. 28, 2015

Related U.S. Application Data
(60) Provisional application No. 62/133,704, filed on Mar. 16, 2015.

(51) Int. Cl. G06F 3/0481; G09G 5/14; G06F 3/0484

(52) U.S. Cl. CPC G06F 3/0481; G06F 3/04842; G09G 5/14

(57) ABSTRACT

A computing device is configured to provide multi-window interaction with a source of hierarchical data. The computing devices includes a display, a processor configured to execute programmatic instructions, and a computer-readable storage media containing a sequence of instructions that, when executed by the processor, provide a thin-client application configured to interact with the source of hierarchical data. The thin-client application provides a first user interface relative to the source of hierarchical data and a second user interface relative to a selection of hierarchical data in the first user interface. The first and second user interfaces are rendered simultaneously in response to a user input requesting multi-window display.

### CROSS-REFERENCE TO RELATED APPLICATION

The present application is based on and claims the benefit of U.S. provisional patent application Ser. No. 62/133,704, filed Mar. 16, 2015, the content of which is hereby incorporated by reference in its entirety.

### BACKGROUND

Computer systems are currently in wide use. Some computer systems are relatively large and may model the various operations of an entire enterprise or operation. Typically, effective modeling of a large operation will employ an extensive hierarchy of interrelated data. In order to effectively interact with the hierarchical interrelated data, such systems provide various forms and report, which are generally surfaced to a user through a rich client application executing on a client device that is on the same local area network as the computer system. Some systems may include, for instance, thousands of different forms (e.g. electronic fillable documents) and other types of elements. By having such forms or views available, users can cross-check and enter data more effectively and easily.

Some computer systems that manage significant amounts of hierarchical, interrelated data, such as a business system, are employed in geographically-separated implementations. For example, a user of such system may be located at an office or factory, while the server(s) with which the user interacts may be located thousands of miles away. In such instances, the user will typically interact with the server(s) using a thin client, such as a web browser. While the cloud implementation of the overall system may provide significant benefits to the end users, providing effective interaction with the hierarchical, interrelated data within the design constraints of a thin client, such as a web browser, is a challenge.

The discussion above is merely provided for general background information and is not intended to be used as an aid in determining the scope of the claimed subject matter.

### SUMMARY

A computing device is configured to provide multi-window interaction with a source of hierarchical data. The computing devices includes a display, a processor configured to execute programmatic instructions, and a computer-readable storage media containing a sequence of instructions that, when executed by the processor, provide a thin-client application configured to interact with the source of hierarchical data. The thin-client application provides a first user interface relative to the source of hierarchical data and a second user interface relative to a selection of hierarchical data in the first user interface. The first and second user interfaces are rendered simultaneously in response to a user input requesting multi-window display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a data communication environment in which embodiments described herein are particularly useful.

FIG. 2 is a block diagram of a computing device configured to execute a thin-client application in accordance with embodiments described herein.

FIG. 3 is a diagrammatic view of a user interface provided by a thin-client application communicatively coupled to a data management system in accordance with one embodiment.

FIG. 4 is a diagrammatic view of a user interface illustrating additional details with respect a record selected in FIG. 3.

FIG. 5 is a diagrammatic user interface illustrating the user interfaces of FIGS. 3 and 4 rendered simultaneously within a thin-client application in accordance with one embodiment.

FIG. 6 is a diagrammatic view of a master form rendered by a thin-client application coupled to a data management system in accordance with one embodiment.

FIG. 7 is a diagrammatic view of a plurality of related user interface displays illustrating a multi-window blocking function in accordance with one embodiment.

FIG. 8 is a flow diagram of a computer-implemented method of providing multiple inter-related user interfaces on a thin-client application in accordance with one embodiment.

FIG. 9 is a block diagram of architecture 100, shown in FIG. 1, except that its elements are disposed in a cloud computing architecture.

FIG. 10 provides a general block diagram of the components of a client device that can run a thin-client application that interacts with a data management system in accordance with one embodiment.

FIG. 11 shows one embodiment using a tablet computer.

FIGS. 12 and 13 provide additional examples of devices that can be used with various embodiment described herein.

FIG. 14 provides an example of a smart phone that can be used with various embodiments described herein.

FIG. 15 is one embodiment of a computing environment in embodiments described herein can be deployed.

### DETAILED DESCRIPTION

Embodiments described herein provide a multi-window interface for a thin-client application, such as a web browser, that includes dynamic linking of data provided in the multiple windows. The information displayed in the multiple windows is related. In accordance with an embodiment, as a user enters information into one window, related portions in the other windows automatically update. This dynamic communication between multiple windows allows a user to have an effective view of multi-level, interrelated data within a thin-client application.

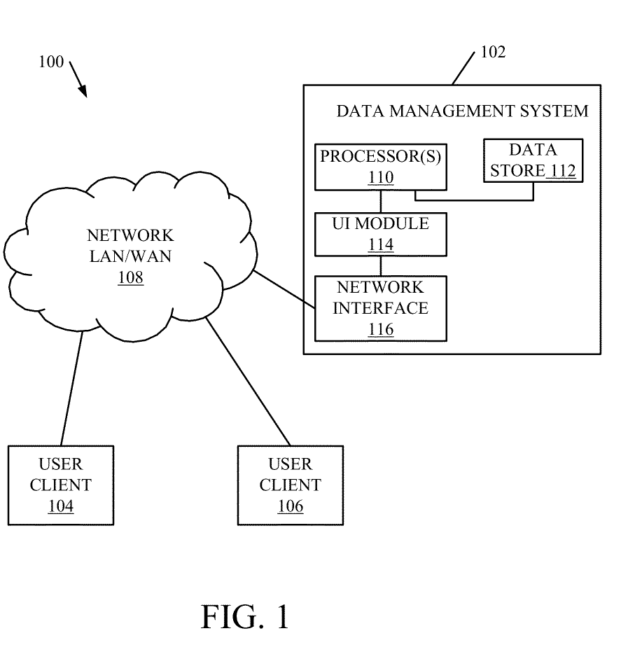

FIG. 1 is a diagrammatic view of a data communication environment in which embodiments described herein are particularly useful. Environment 100 includes data management system 102 communicatively coupled to one or more user clients 104, 106 via network 108. Data management system 102 may be any suitable arrangement of computing devices and/or components thereof that are able to efficiently store significant amounts of interrelated, hierarchical data. Data management system 102 includes one or more processors 110 coupled to data store 112. Processors 110 may be individual microprocessors of one or more computing devices or may be a single processor of a single computing device. Processors 110 interact with data store 112 in order to persist and retrieve data of data management system 102 in data store 112. Data store 112 is arranged, through any suitable combination of hardware and/or software, to store data for convenient retrieval, and/or analysis. Data may be hierarchical in the sense that a particular item of data may have features or characteristics that belong to one or more levels in the hierarchy. For example, data indicative of an order may have one or more sub-items indicative of individual lines of the order, and each individual line of the order may have one or more transactions associated therewith. Similarly, a particular item manufactured or provided by a manufacturer may have a serial number, a model number, a type, et cetera. Further still, the various items of data may be interrelated at various levels in accordance with the particular reality of an individual implementation.

In order to accommodate this variety of structure, data management system 102 is generally provided in a highly customizable fashion that may be tailored for an individual implementation by one or more developers. Once implemented, data management system 102 provides effective interactions with the data to users thereof. Data management system 102 includes user interface (UI) module 114 coupled to processor(s) 110. UI module 114, when executed by one or more processors 110, generates various user interfaces, such as forms, dialogs, reports, et cetera to users of data management system 102. Additionally, as shown in FIG. 1, data management system 102 includes at least one network interface 116 that is coupled to network 108. Network 108 may be any suitable network, such as a local area network, a wide area network, such as the internet, et cetera. Each of clients 104, 106 is communicatively coupled to data management system 102 via network 108. Each user client 104, 106 executes a thin-client application that includes, or is provided with, a uniform resource locator (URL) that specifies communication to data management system 102. Thin-client applications provide important advantages for interacting with data management system 102, even in implementations where network 108 is a local area network. This is because thin-client applications, such as web browsers, are ubiquitous and are provided for execution upon virtually any computing hardware platform available.

Various thin-client applications, such as web browsers, typically implement a certain degree of standardized functionality. While the ubiquity and standardization facilities interoperability and widespread use of data management system 102, it can provide challenges for data interactions where multi-level views of data are necessary. In accordance with various embodiments herein, a multi-window interface is provided within a thin-client application, such as a web browser, that includes dynamic linking of data provided in the multiple windows. The information displayed in the multiple windows is related. In accordance with an embodiment, as a user enters information into one window, related portions in the other windows automatically update. This dynamic communication between multiple windows allows a user to have an effective view of multi-level, interrelated data within the thin-client application. Accordingly, at least some of the advantages of previous rich-client interactions with hierarchical, interrelated data are extended to thin-client applications within the design constraints of such thin-client applications.

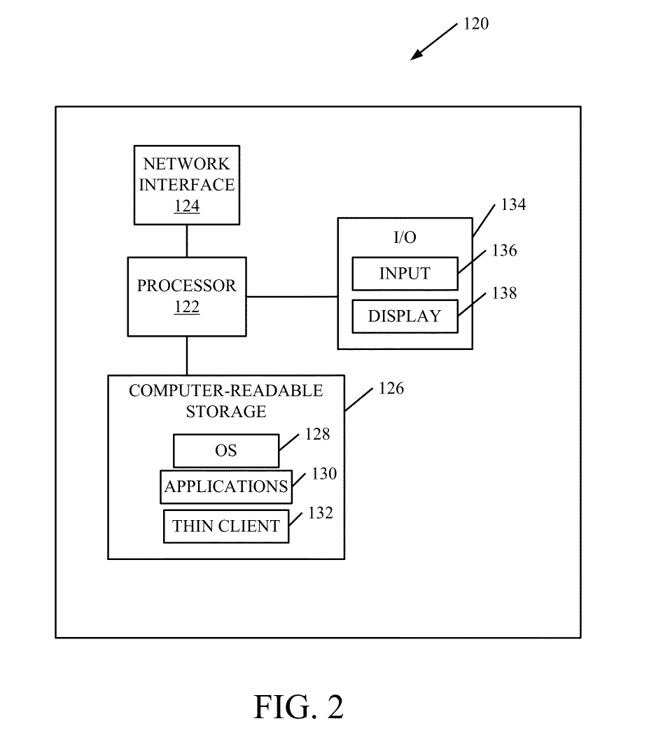

FIG. 2 is a diagrammatic view of a client computing system with which embodiments described herein are applicable. Computing device 120 may be any suitable computing device including a desktop computer, a tablet computer, a laptop computer, a smartphone, or any other device that may execute thin-client applications. Computing device 120 includes processor 122 that is typically a microprocessor. Processor 122 is coupled to network interface 124 that allows device 120 to communicate with one or more external devices or networks in accordance with a suitable communication technology, such as cellular communication (GPRS, GSM, et cetera.), Wi-Fi, Ethernet, et cetera. Processor 122 is coupled to computer-readable storage 126, which includes at least some non-volatile storage, such as flash memory, programmable read only memory (PROM), et cetera. Further, computer-readable storage 126 may also include volatile memory, such as random access memory (RAM) for supporting programmatic execution within processor 122. However, processor 122 may also have its own volatile memory (not shown independently). Computer readable-storage 126, in one embodiment, contains or stores a number of instructions that, when executed by processor 122 provide operating system functionality 128. Additionally, computer-readable storage 126 also includes applications 130 that, when executed by processor 122, perform their designed functions. One example of applications 130 is thin-client 132. Thin-client application 132, when executed by processor 122, generates a thin-client user interface to a remote information provider, such as a web server. Accordingly, thin-client application 132 is generally supplied with a uniform resource locator (such as a web address) that causes processor 122 to communicate with the selected web server via network interface 124 in order to retrieve information indicative of a user interface. Thin-client application 132 then causes processor 122 to display the received user interface information received from the selected web server via display 138 of input/output module 134. A user may interact with the displayed user interface via one or more inputs that are received by input module 136. A common example of device 120 is a desktop computer running a web browser application, such as Internet Explorer, available from Microsoft Corporation, of Redmond, Wash.

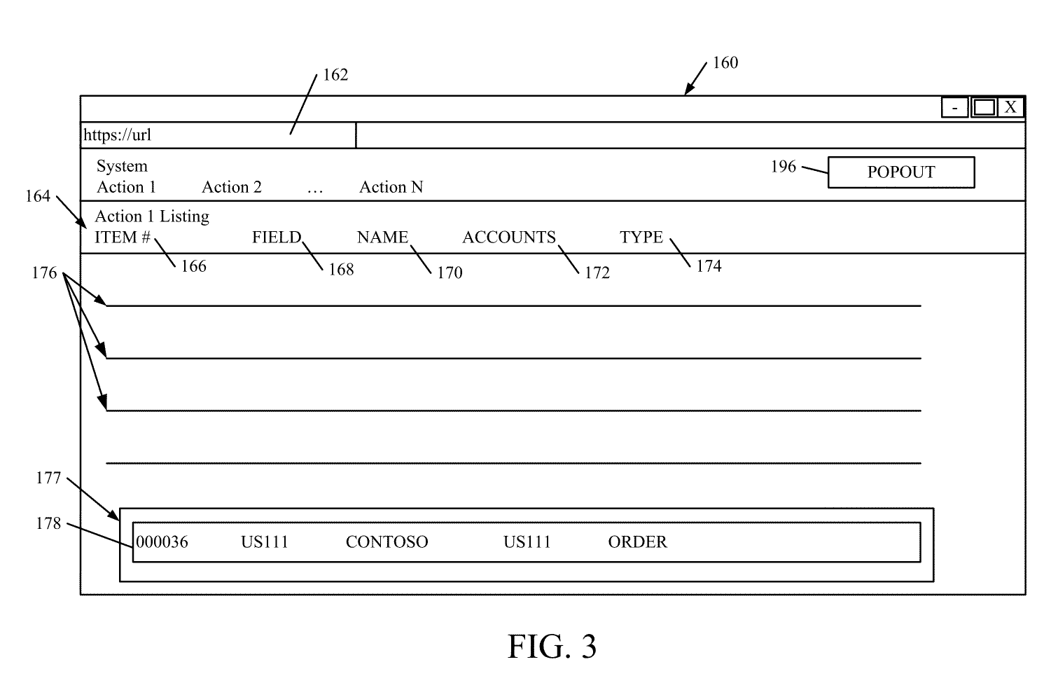

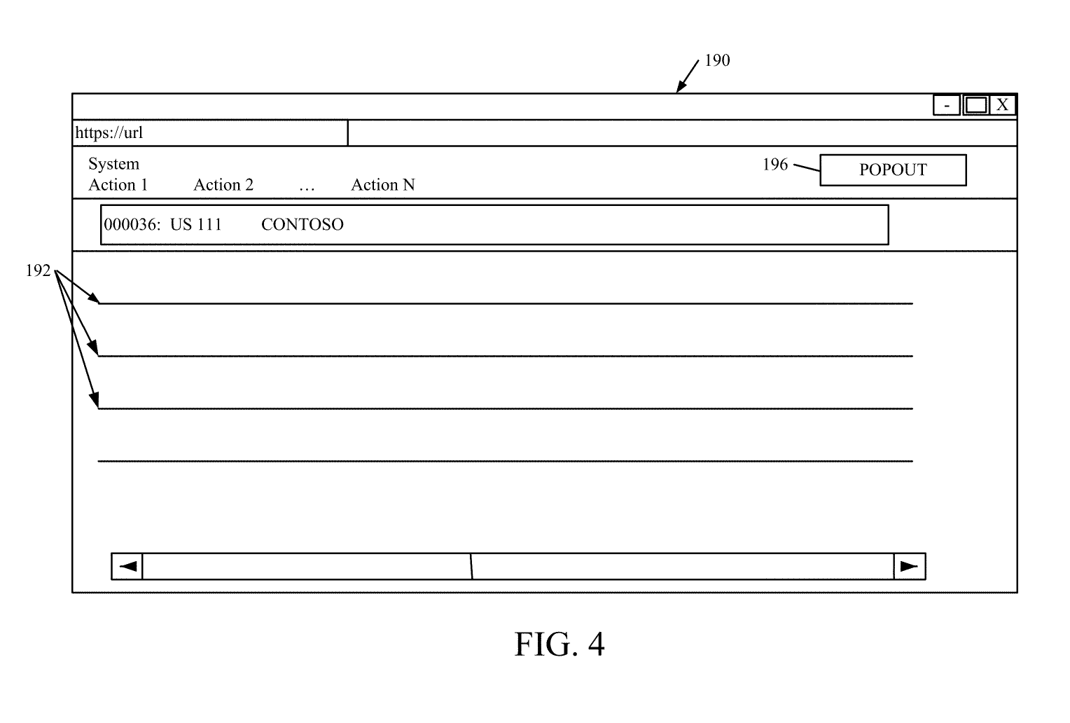

FIG. 3 is a diagrammatic view of a user interface displayed by a thin-client relative to hierarchical, interrelated data, in accordance with one embodiment. Interface 160, in the illustrated embodiment, includes a URL window 162 indicating the uniform resource locator parameter relative to the data management system to which the thin-client is communicatively coupled. Accordingly, simply changing the information provided in field 162 can direct the thin-client application to an entirely different data management system 102. As illustrated in FIG. 3, the current system to which display 160 is coupled provides a number of actions: Action 1, Action 2. . . Action N relative to data of the data management system 102. In one embodiment, such actions may be grouped according to their functions such as actions related to the following functions: Purchase order, Purchase, Manage, Receive, Invoice, Retail, Warehouse, Transportation, General, et cetera. However, the various types of actions should not be considered as limiting and various actions will be suitable for different implementations. Interface 160 includes a listing relative to Action 1 in region 164. As shown, a number of columns: Item 166, Field 168, Name 170, Accounts 172, and Type 174 are provided. Individual rows, 176 indicate data having information set forth in the specified fields. In the embodiment shown, one particular row 177 is highlighted, as indicated at reference numeral 178. In the example, the Item number for the highlighted row has a value of 00036, and Field 168 for row 178 has a value of US111. Additionally, Name field 170 for row 178 has a value of “CONTOSO” and the Accounts 172 of row 178 is shown as US111. Additionally, Type 174 in row 178 has the value “ORDER.” When a user selects row 178, a more detailed view of that particular item (shown in FIG. 4) is generated providing additional information.

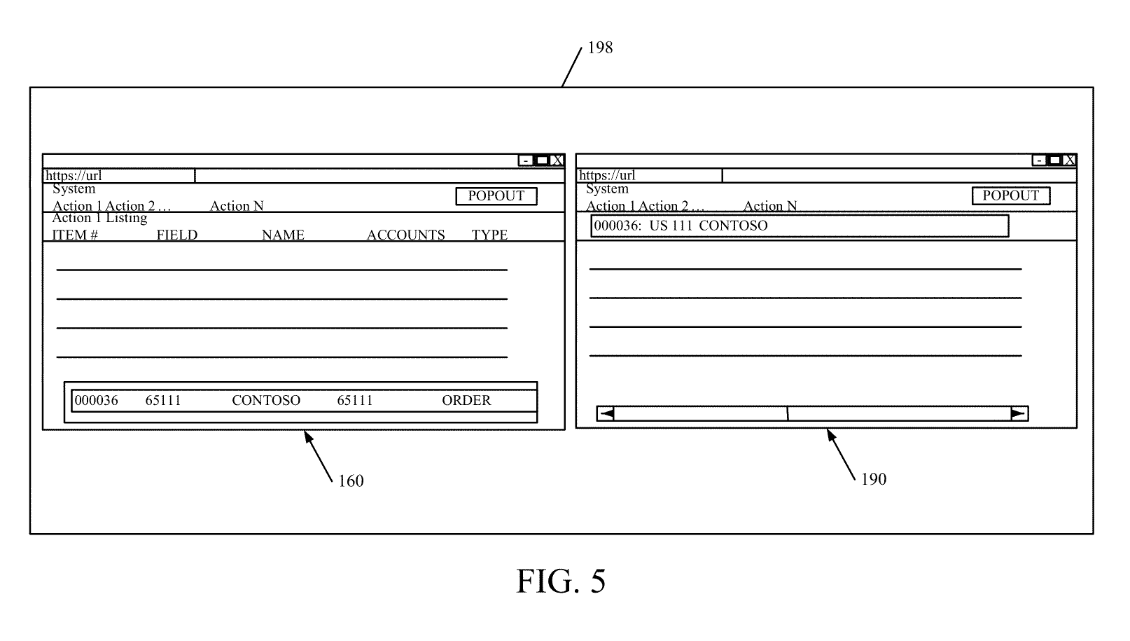

FIG. 4 is a diagrammatic view of a user interface rendered within a thin-client application in accordance with one embodiment. User interface 190 shows details with respect to row 177 being after a user has selected or otherwise expanded row 177 while user interface 160 was shown. Again, a number of actions are available to the user. Further, various details of the particular row 177 data are shown in user interface 190, that are not shown in user interface 160. These items are indicated at reference numeral 192. As shown in FIGS. 3 and 4, a user interface element (popout button 196) is available for a user to engage. If a user should engage user interface element 196 while user interface 190 is displayed, the thin-client application will transition to a multi-window display, as shown in FIG. 5, in accordance with one embodiment.

FIG. 5 illustrates user interface display 190 within a display 198 of the client device next to (in one embodiment) user interface 160, which is the user interface of the thin-client application that was shown prior to the user interface that was displayed (user interface 190) when element 196 was engaged. Thus, user interface 160 will illustrate data at a first level, while user interface 190 will illustrate related data at a second or different level. In this way, a user can view individual details of a particular item, and move among items more easily. For example, a user may select a different row in user interface 160, which will then surface the appropriate details of the newly-selected row in user interface 190. Similarly, changes made to details in user interface 190 are automatically reflected back to the corresponding information in user interface 160.

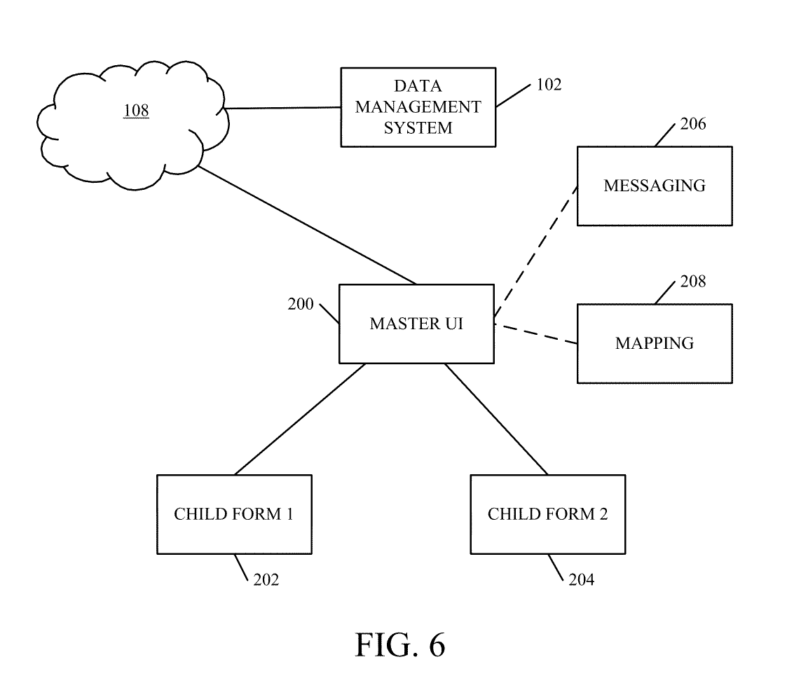

FIG. 6 is a diagrammatic view of an arrangement of multiple windows for providing user interaction with multiple levels of related data in a thin-client application in accordance with one embodiment. An important feature of a multi-window user interface is the ability to have any changes made in one window reflected to associated data in other windows. In accordance with one embodiment, the first thin-client application user interface is deemed a master user interface 200. Subsequent user interfaces that are generated when a user selects the multi-window user interface element, such as element 196, when a previous user interface display has been generated (such as user interface 190 being shown after user interface 160 was shown will generate a child form, such as first child form 202). Subsequently, if the user returns to master form 200 and selects a different aspect of data to display and selects user interface element 196 a second child form, such as second child form 204 will be displayed. While the example shown in FIG. 6 includes three displays (200, 202, and 204) any suitable number of displays may be used. The physical location of the various displays on the screen or screens of the device executing the thin-client application can be provided in any suitable manner. Examples include setting the displays side by side, overlaying the displays, providing a panoramic view to the displays, et cetera. Additionally, any combination of the display positioning listed above can be used. Providing the user with the ability to position the various user interfaces on the display(s) allows the user to utilize multiple monitors more effectively.

Master UI 200 includes or is coupled to messaging module 206 as well as mapping module 208. Messaging module 206 ensures that the flow of messages to master UI 200, as well as any of its children 202, 204 is performed effectively. Mapping module 208 includes an indication of which data is provided by which child form 202, 204. In this way, as master UI 200 receives information from data management system 102, information is conveyed to the appropriate forms 202, 204 via messaging module 206. In one embodiment, displays, 200, 202, and 204 share the same session identification value at data management system 102. Thus, the physical resources of data management system 102 are conserved even as multiple, related user interfaces are spawned and used. In this way, no additional load is provided on data management system 102 even as significant additional data interaction functionalities are provided by the various interface. In one embodiment, the messaging between master user interface 200 and associated forms 202, 204 is provided using JavaScript. Additionally, in one embodiment, the thin-client application is compliant with at least one suitable thin-client application standard, such as HTML 5.

Messaging module 206 can be considered a dispatcher in that it will invoke code and notify appropriate interfaces on changes of state (across thread and/or across session). Additionally, in one embodiment, when a form is executed, an additional property can be added to the parameters passed to the form execution method that will couple the form to messaging module 206 such that inter-form communication is enabled. Messaging module 206 supports requests to invoke specific code on a UI thread as well as to call a refresh on the master UI 200. Additionally, Messaging module 206 notifies listener dispatchers (subscribed to or otherwise coupled to messaging module 206) that the current object has changed state. However, those skilled in the art will recognize that other forms of communication between the various user interfaces can be employed in accordance with the various embodiments described herein. Additionally, while embodiments have been described with respect to the various user interfaces having the same session, it is contemplated that embodiments can be practiced where the different user interfaces have different session identifiers on data management system 102. Further still, while embodiments have been described with respect to multiple windows operating within a single thin-client application on a single device, embodiments can be practiced wherein multiple related windows are provided across multiple thin-client applications on one or more computing devices.

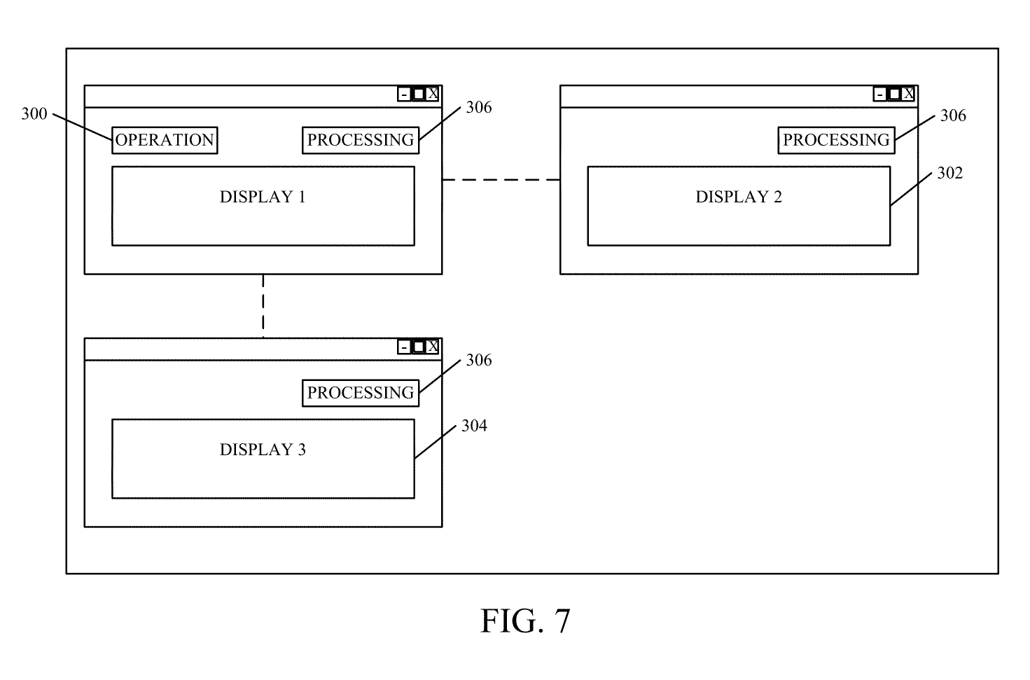

FIG. 7 is a diagrammatic view of a user interface blocking function for multiple windows of a thin-client application in accordance with one embodiment. As set forth above, embodiments described herein generally provide substantially real-time messaging and updating of various of interrelated forms as they show various levels of interrelated data. However, at least some functions of data management system 102 may provide operations on the data that require enough time that allowing a user to make changes to related data in other windows could generate errors or cause corruption. Accordingly, in one embodiment, the thin client application provides a blocking function across all windows whenever an operation on the related data is executed. In the example shown in FIG. 7, an operation is selectable by a user by engaging user interface element 300. One example of such operation may be reconciling a series of transactions. The execution of operation 300 may take a number of seconds to complete. It is important that forms illustrated in display 2 (302) and display 3 (304) not be allowed to change the data while the operation is being performed. In this way, when an operation in one of the displays is engaged, all related displays 302, 304 are blocked from receiving user interactions. In one embodiment, a visual indicator, such as a flashing “Processing” display 306 is shown in all displays. Thus, regardless of the particular window to which the user's attention is drawn, the user will know that an operation is being performed, and that user input is blocked for the moment. Once the operation is complete, indication 306 will disappear or change to indicate that user input is no longer blocked.

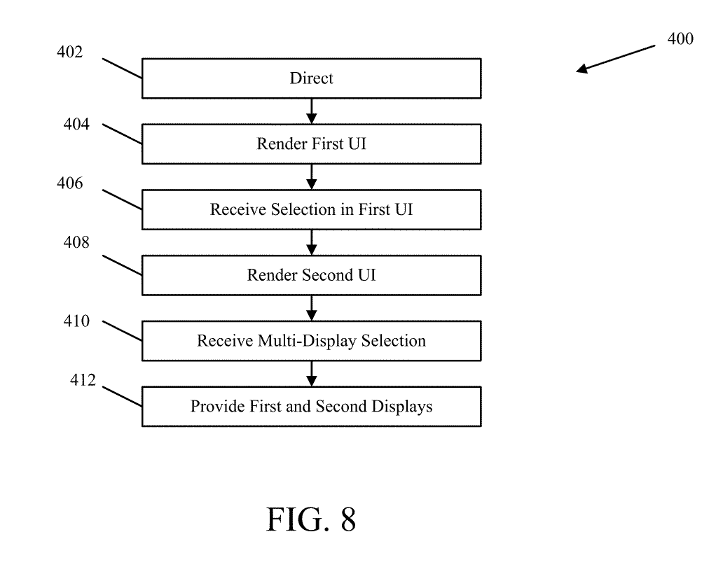

FIG. 8 is a flow diagram of a computer-implemented method of providing multiple inter-related user interfaces on a thin-client application in accordance with one embodiment. Method 400 begins at block 402 where a thin-client application, executing on a computing device, is directed to a source of inter-related, hierarchical data, such as data management system 102. Next, at block 404, the thin-client application renders a first user interface, such as user interface 160 relative to the source of inter-related, hierarchical data. At block 406, the thin-client application receives user input through the first interface that selects an aspect or portion of data in the first interface, such as row 177 (shown in FIG. 3). In response to the user input received at block 406, the thin-client application renders a second user interface, such as user interface 190 (shown in FIG. 4), as indicated at block 408. The data presented in the second user interface is related to the selection in the first user interface, but presents different (such as additional) details with respect to the data. At block 410, a request for a multi-window display is received via the second user interface, and the thin-client application responsively renders first and second user interfaces simultaneously. When simultaneously rendered, changes made to data in one user interface may automatically be reflected in the other user interface, and vice versa.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, et cetera. They can also be actuated in a wide variety of different ways. For instance, they can be actuated using a point and click device (such as a track ball or mouse). They can be actuated using hardware buttons, switches, a joystick or keyboard, thumb switches or thumb pads, et cetera. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

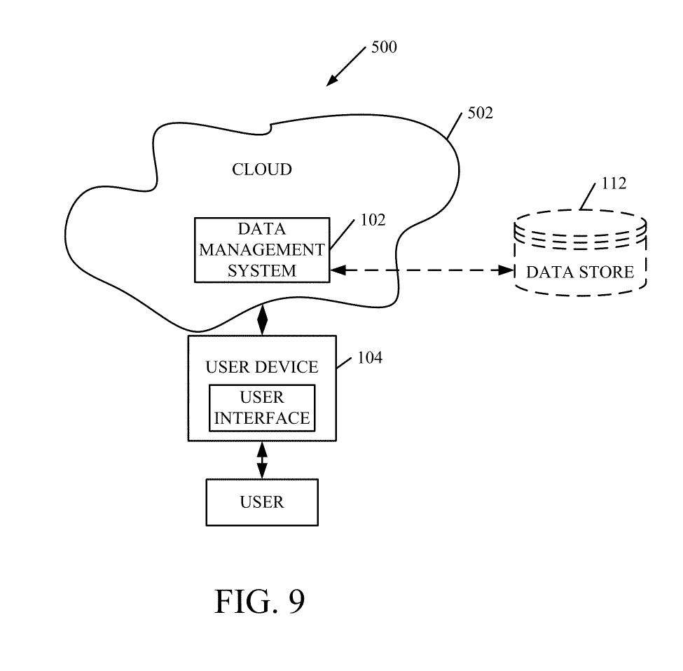

FIG. 9 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

FIG. 9 also depicts another embodiment of a cloud architecture. FIG. 9 shows that it is also contemplated that some elements of data management system 102 are disposed in cloud 502 while others are not. By way of example, data store 112 can be disposed outside of cloud 502, and accessed through cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

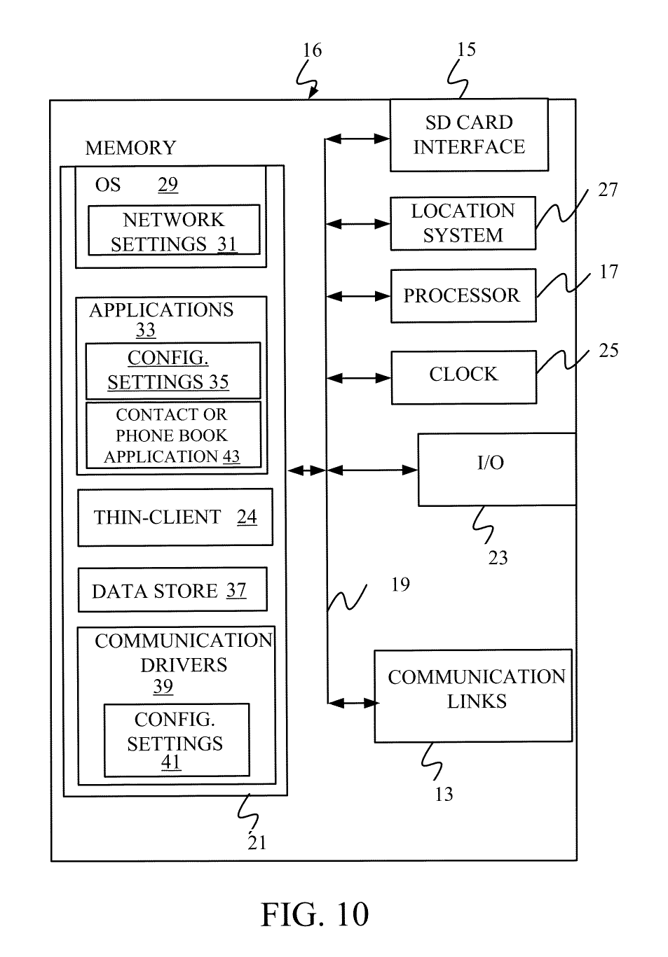

FIG. 10 provides a general block diagram of the components of a client device 16 that can run a thin-client application that interacts with data management system 102. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1× rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Device 16 can have a thin-client application 24 which can be directed to interact with data management system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

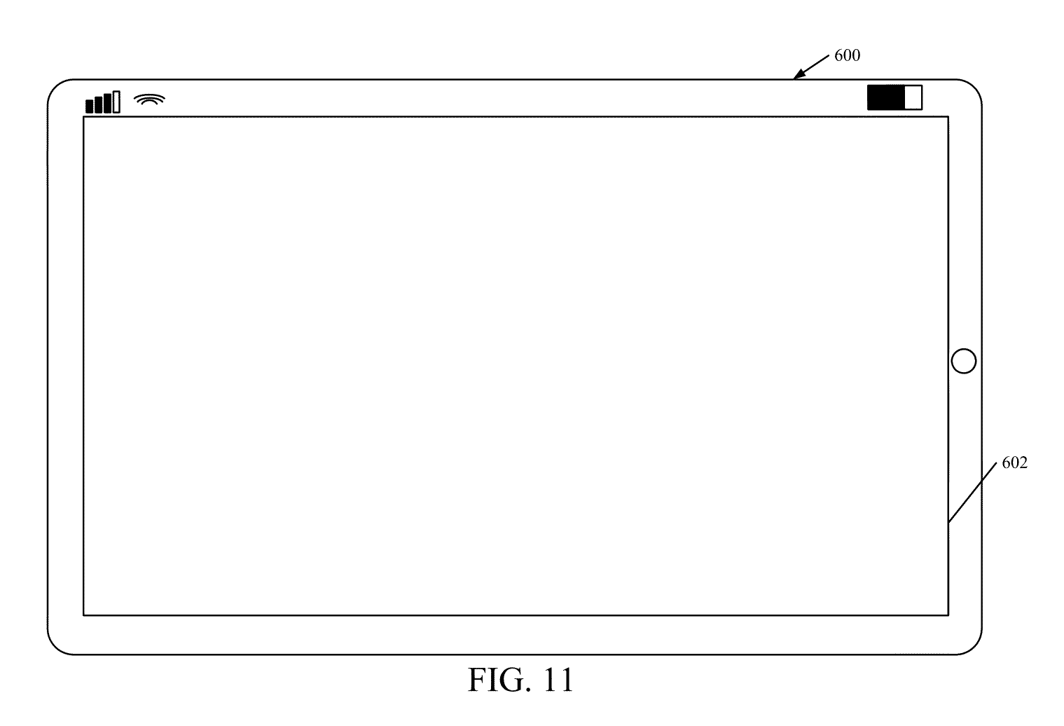

FIG. 11 shows one embodiment in which device 16 is a tablet computer 600. In FIG. 10, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

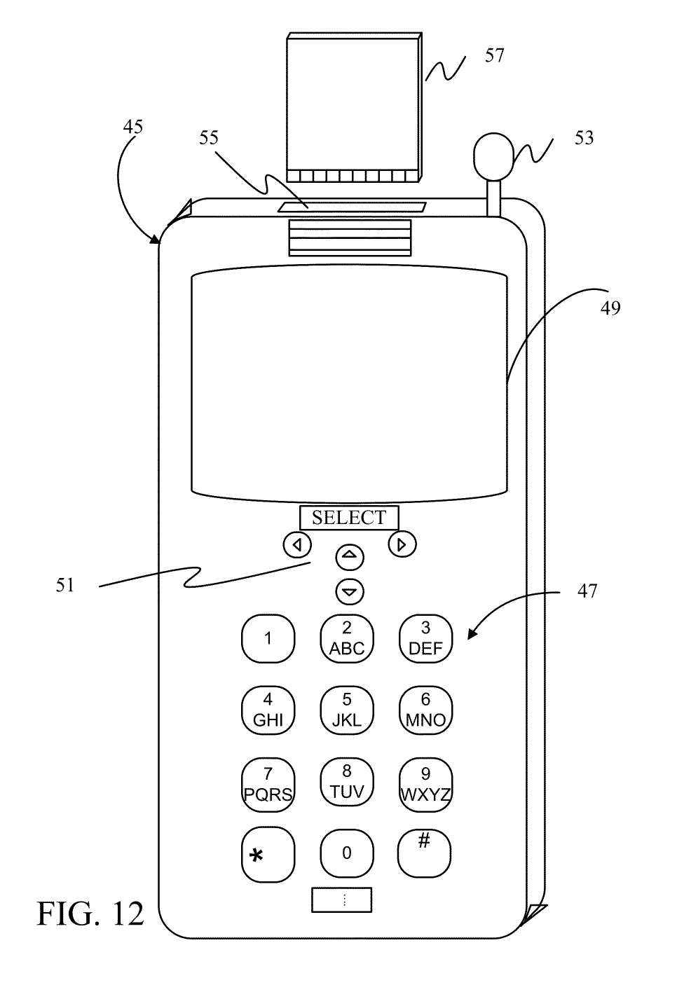

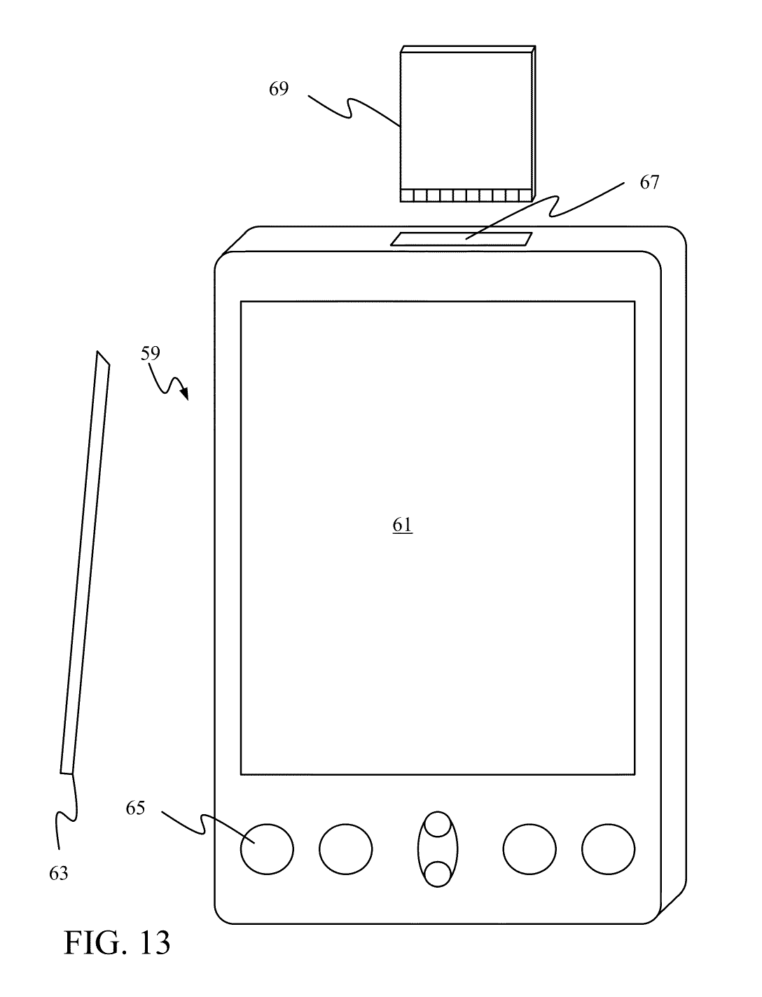

FIGS. 12 and 13 provide additional examples of devices 16 that can be used, although others can be used as well. In FIG. 12, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1× rtt, and Short Message Service (SMS) signals. In some embodiments, phone 45 also includes a Secure Digital (SD) card slot 55 that accepts a SD card 57.

The mobile device of FIG. 13 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

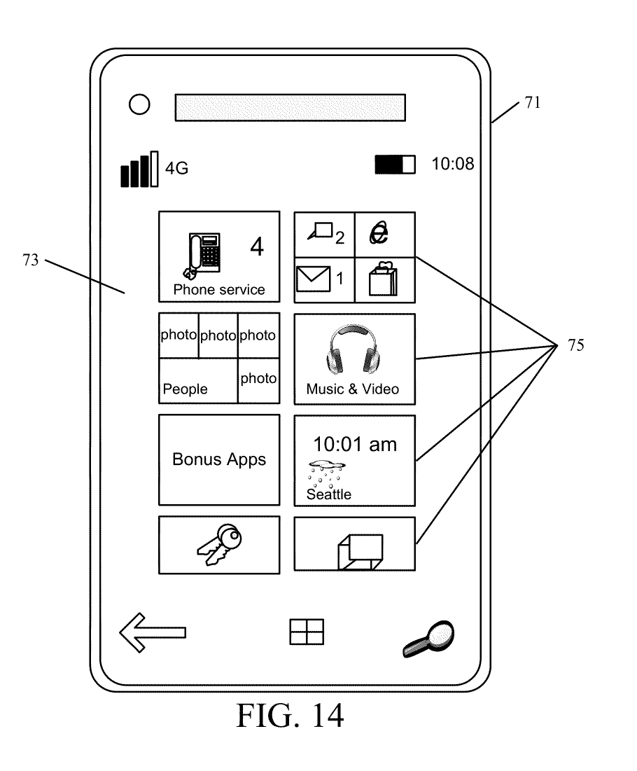

FIG. 14 is similar to FIG. 12 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

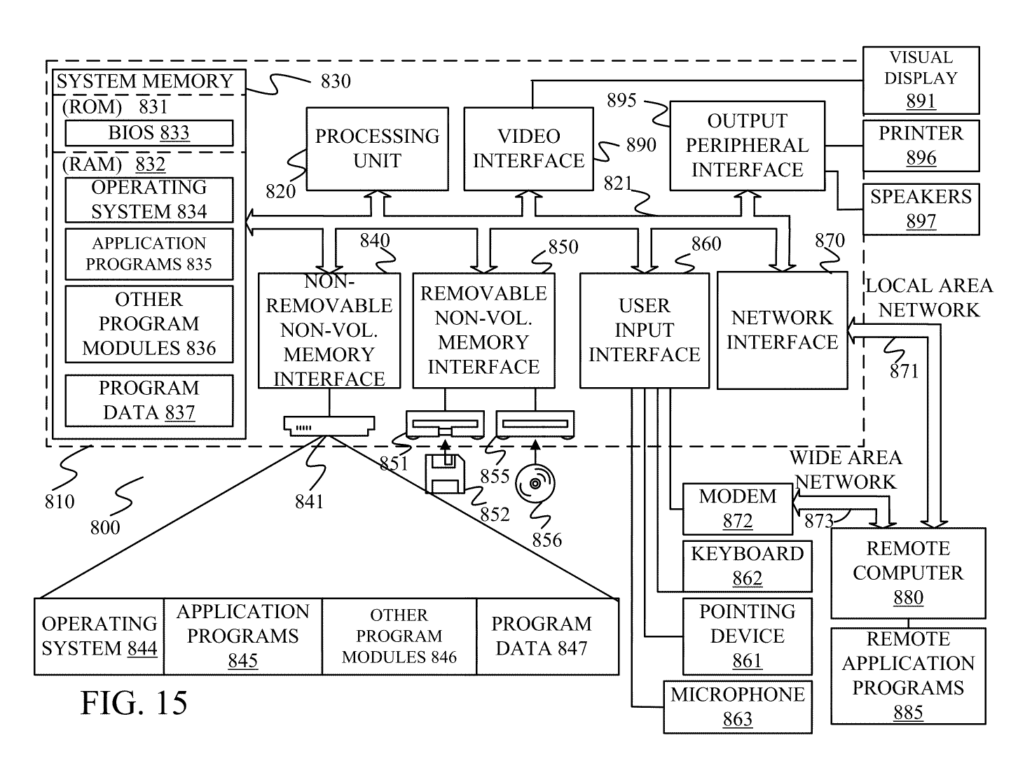

FIG. 15 is one embodiment of a computing environment in which architecture 100, or parts of it, (for example) can be deployed. With reference to FIG. 15, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 15.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), et cetera.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes or is coupled to a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 15 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing device is configured to provide multi-window interaction with a source of hierarchical data. The computing devices includes a display, a processor configured to execute programmatic instructions, and a computer-readable storage media containing a sequence of instructions that, when executed by the processor, provide a thin-client application configured to interact with the source of hierarchical data. The thin-client application provides a first user interface relative to the source of hierarchical data and a second user interface relative to a selection of hierarchical data in the first user interface. The first and second user interfaces are rendered simultaneously in response to a user input requesting multi-window display.

Example 2 is the computing device of any or all previous examples wherein the first and second user interfaces are communicatively coupled such that changes made to data displayed in one user interface are automatically applied to data in the other user interface.

Example 3 is the computing device of any or all previous examples wherein the first and second user interfaces have an identical session identifier relative to the source of hierarchical data.

Example 4 is the computing device of any or all previous examples wherein the first user interface is a master user interface.

Example 5 is the computing device of any or all previous examples wherein the second user interface is a child user interface receiving information via the master user interface.

Example 6 is the computing device of any or all previous examples wherein the thin-client application includes a messaging module that conveys information from the first user interface to the second user interface.

Example 7 is the computing device of any or all previous examples wherein the messaging module is a dispatcher that is configured to invoke code that provides a notification of a change of state.

Example 8 is the computing device of any or all previous examples and further comprising a third user interface rendered simultaneously with the first and second user interfaces and wherein the notification is provided to all user interfaces.

Example 9 is the computing device of any or all previous examples wherein the notification is provided to at least one subscriber.

Example 10 is the computing device of any or all previous examples wherein the first and second user interfaces are rendered side-by-side.

Example 11 is the computing device of any or all previous examples wherein the first and second user interfaces are rendered on the display.

Example 12 is the computing device of any or all previous examples wherein the thin-client application includes a mapping module containing an indication of which data from the source of hierarchical data is provided by the second user interface.

Example 13 is the computing device of any or all previous examples and further comprising a third user interface rendered simultaneously with the first and second user interfaces and wherein the mapping module contains an indication of which data from the source of hierarchical data is provided by each of the second and third interfaces.

Example 14 is a computer-implemented method for interacting with inter-related, hierarchical data using a thin-client application. The method includes directing the thin-client application to a source of inter-related, hierarchical data. A first display of the inter-related, hierarchical data is rendered. A user input is received selecting an aspect of the first display. A second display of the inter-related, hierarchical data is rendered. An input requesting multi-window display is received and the first and second displays are responsively provided showing inter-related data. The first and second displays are communicatively coupled together.

Example 15 is the computer-implemented method of any or all previous examples wherein directing the thin-client application to the source of inter-related, hierarchical data includes supplying a uniform resource locator to the thin-client application.

Example 16 is the computer-implemented method of any or all previous examples and further comprising receiving a user modification to data displayed in one of the first and second displays and automatically updating the other of the first and second displays based on the modification.

Example 17 is the computer-implemented method of any or all previous examples wherein the first and second displays are rendered on a single device.

Example 18 is the computer-implemented method of any or all previous examples and further comprising receiving a user input relative to one of the first and second displays, executing an operation relative to data displayed in the first and second windows, and blocking interaction with the first and second displays while the operation executes.

Example 19 is the computer-implemented method of any or all previous examples wherein receiving an input requesting multi-window display includes sensing a user action relative to a user interface element provided on the second display.

Example 20 is a data management system for inter-related hierarchical data. The data management system includes a processor and a data store coupled to the processor that contains the inter-related, hierarchical data. A user interface module is coupled to the processor and is configured to generate a plurality of user interfaces. A network interface is coupled to the user interface module and configured to couple the data management system to a network. The user interface module is configured to provide a plurality of user interfaces to a thin-client application, where each of the plurality of user interfaces has an identical session identifier.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to provide multi-window interaction with a source of hierarchical data, the computing device comprising:
a display;
a processor configured to execute programmatic instructions;
a computer-readable storage media containing a sequence of instructions that, when executed by the processor, provide a thin-client application configured to interact with the source of hierarchical data and provide a first user interface relative to the source of hierarchical data, and provide a second user interface relative to a selection of hierarchical data in the first user interface; and
wherein the first and second user interfaces are rendered simultaneously in response to a user input requesting multi-window display.

2. The computing device of claim 1, wherein the first and second user interfaces are communicatively coupled such that changes made to data displayed in one user interface are automatically applied to data in the other user interface.

3. The computing device of claim 1, wherein the first and second user interfaces have an identical session identifier relative to the source of hierarchical data.

4. The computing device of claim 1, wherein the first user interface is a master user interface.

5. The computing device of claim 4, wherein the second user interface is a child user interface receiving information via the master user interface.

6. The computing device of claim 1, wherein the thin-client application includes a messaging module that conveys information from the first user interface to the second user interface.

7. The computing device of claim 6, wherein the messaging module is a dispatcher that is configured to invoke code that provides a notification of a change of state.

8. The computing device of claim 7, and further comprising a third user interface rendered simultaneously with the first and second user interfaces and wherein the notification is provided to all user interfaces.

9. The computing device of claim 7, wherein the notification is provided to at least one subscriber.

10. The computing device of claim 1, wherein the first and second user interfaces are rendered side-by-side.

11. The computing device of claim 1, wherein the first and second user interfaces are rendered on the display.

12. The computing device of claim 1, wherein the thin-client application includes a mapping module containing an indication of which data from the source of hierarchical data is provided by the second user interface.

13. The computing device of claim 12, and further comprising a third user interface rendered simultaneously with the first and second user interfaces and wherein the mapping module contains an indication of which data from the source of hierarchical data is provided by each of the second and third interfaces.

14. A computer-implemented method for interacting with inter-related, hierarchical data using a thin-client application, the method comprising:
directing the thin-client application to a source of inter-related, hierarchical data;
rendering a first display of the inter-related, hierarchical data;
receiving a user input selecting an aspect of the first display;
rendering a second display of the inter-related, hierarchical data;
receiving an input requesting multi-window display; and
responsively providing the first and second displays showing inter-related data, wherein the first and second displays are communicatively coupled together.

15. The method of claim 14, wherein directing the thin-client application to the source of inter-related, hierarchical data includes supplying a uniform resource locator to the thin-client application.

16. The method of claim 14, and further comprising receiving a user modification to data displayed in one of the first and second displays and automatically updating the other of the first and second displays based on the modification.

17. The method of claim 14, wherein the first and second displays are rendered on a single device.

18. The method of claim 14, and further comprising receiving a user input relative to one of the first and second displays, executing an operation relative to data displayed in the first and second windows, and blocking interaction with the first and second displays while the operation executes.

19. The method of claim 14, wherein receiving an input requesting multi-window display includes sensing a user action relative to a user interface element provided on the second display.

20. A computing device configured to provide multi-window interaction with a source of hierarchical data, the computing device comprising:
a display;
a processor configured to execute programmatic instructions;
a computer-readable storage media containing a sequence of instructions that, when executed by the processor, provide a thin-client application configured to interact with the source of hierarchical data and provide a first user interface relative to the source of hierarchical data and a user interface element on the first user interface; and
wherein, upon actuation of the user interface element, the thin-client application is configured to provide a second user interface that remains connected to the first user interface to allow interaction with both of the first and second user interfaces.
